(19) United States
(12) Patent Application Publication
(10) Pub. No.: US 2018/0075116 A1
(43) Pub. Date: Mar. 15, 2018

(54) INFORMATION PROCESSING SYSTEM, CONTROL DEVICE, AND COMPUTER-READABLE RECORDING MEDIUM HAVING PROCESSING PROGRAM RECORDED THEREIN

(71) Applicant: FUJITSU LIMITED, Kawasaki-shi (JP)

(72) Inventor: Minoru Nakamura, Kawasaki (JP)

(73) Assignee: FUJITSU LIMITED, Kawasaki-shi (JP)

(21) Appl. No.: 15/686,607

(22) Filed: Aug. 25, 2017

(30) Foreign Application Priority Data
Sep. 12, 2016 (JP) 2016-177518

(51) Int. Cl. G06F 17/30

(52) U.S. Cl. CPC G06F 17/30569; G06F 17/30598; G06F 17/30324; G06F 17/30315; G06F 17/30371

(57) ABSTRACT

An information processing system includes: a storage device configured to store a row-oriented database and a column-oriented database converted from the row-oriented database; and a control device configured to control the storage device, and the control device is configured to group a plurality of records included in the row-oriented database into a plurality of groups, and convert each of the groups into a column group conforming to a format of the column-oriented database.

### CROSS-REFERENCE TO RELATED APPLICATION

This application is based upon and claims the benefit of priority of the prior Japanese Patent Application No. 2016-177518, filed on Sep. 12, 2016, the entire contents of which are incorporated herein by reference.

### FIELD

The present invention relates to an information processing system, a control device, and a computer-readable recording medium having a processing program recorded therein.

### BACKGROUND

One data in a relational database (RDBMS) is called a record or a tuple. One record includes a plurality of attributes such as a “name”, a “birthday” and an “address”. A collection of a plurality of records is a table or a relation. An operation of inserting, deleting or searching for a record in a table is executed in the RDBMS.

The table is a “set of records” in terms of a design concept, and can also be interpreted as two-dimensional information having vertical and horizontal directions. An attribute of a record is a column, and each record is a row. When the RDBMS is actually mounted, the table is stored in storage on a calculator. In this regard, an arrangement of columns and rows includes the following three types.
N-ary storage model (NSM): Attributes in a record are determined and are stored in one storage (row orientation).
Decomposition storage model (DSM): Each attribute is divided and is stored in storage (column orientation).
Partition attributes across (PAX): A fixed number of records are arranged per attribute, and are stored in the storage.

A relatively old database adopts the NSM (row orientation). Performance to insert, delete and update records is important for such a database, and data arranged in record units on the storage can be easily read and written. Such a database is, for example, a former model of ORACLE (registered trademark) Database released in 1977, and DB2 (registered trademark) released from IBM (registered trademark) in 1983.

Meanwhile, business intelligences and data warehouses such as Sybase IQ (registered trademark) and Teradata (registered trademark) generally adopt the DSM. This is because all records in a table are usually read during data analysis yet only attributes of a specific number of all attributes in the record need to be read. A database adopting the DSM is referred to as a column-oriented database or a columnar. Further, column-specific data is readily compressed (has good compression efficiency), a space on a disk becomes small by highly efficient compression, an input/output (I/O) during reading is reduced and performance improves. Hence, the columnar generally performs compression.

In recent years, a demand for column-oriented databases is increasing, and various column-oriented databases are being developed. At a research level, C-Store, MonetDB, X100 and HyPer are developed, and HP Vertica and Vectorwise (Action Vector) are developed for commercial use. Further, the row-oriented database optionally adds a column-oriented database function by IBM DB2 BLU Acceleration or Oracle 12c.

Meanwhile, a method for preparing an “index” of a columnar for a table of a row-oriented database to perform analysis add-in columnar on a conventional row-oriented database is known. The method is, for example, a Columnstore Indexes function of SQL Server 2012 of Microsoft (registered trademark) and a column store index (CSI) function of Fujitsu Laboratories, Ltd.

In this regard, the above “index” means that there is a mechanism which helps table scan in terms of a database, and does not mean that a designated key is not sorted unlike a normal index. The following columnar index will be referred to as a “column store index” or simply as a “column store”.

### LIST OF RELATED ART DOCUMENTS

Patent Document 1: Japanese Laid-open Patent Publication No. 2010-539616

Patent Document 2: Japanese Laid-open Patent Publication No. 2014-13562

Patent Document 3: Japanese Laid-open Patent Publication No. 2001-14329

Non-Patent Document 1: FUJITSU LABORATORIES LTD., “Study of Realization of Column Store Mechanism based on PostgreSQL”, Minoru NAKAMURA, Tsuguchika TABARU, Yoshifumi UJIBASHI, Takushi HASHIDA, Motoyuki KAWABA, Lilian HARADA, DEIM Forum 2015, [online], Mar. 3, 2015, [searched on Jul. 5, 2016], Internet <URL://db-event.jpn.org/deim2015/paper/195.pdf>

Non-Patent Document 2: Microsoft Corporation, “Explanation of SQL Server 2014 Columnstore Index”, [online], [searched on Jul. 5, 2016] Internet <URL://msdn.microsoft/com/ja-jp/library/gg492088%28v=sql.120%29.aspx>

A columnar is known to have low performance of an update process such as INSERT/DELETE/UPDATE. This is caused when the columnar divides one row per column and writes each column in a plurality of items of column specific data, and each column specific data is compressed. A cache of a small volume which stores a row format separately from a column store is generally provided to improve a columnar update speed. This cache will be referred to as a delta store or a write optimized store (WOS).

When the column store index is adopted, as illustrated in FIG. 15, INSERT/DELETE/UPDATE for an original table 1100 is first stored in a delta store 1200. When information of inserted, updated and deleted rows of a fixed amount is stored in the delta store 1200, a plurality of rows is collectively converted into data in a column store 1300. The converted data will be referred to as a column segment in SQL Server, and as an extent in CSI of Fujitsu Laboratories, Ltd. FIG. 15 illustrates an example where there are column segments 1400-1 and 1400-2 in the column store 1300. When there is a pair of an inserted row and a deleted row in the delta store among rows accumulated in the delta store 1200, it is also possible to perform optimization by annihilating the pair during conversion into a column segment and not writing the pair in the column store.

Meanwhile, an original table is managed in row units. For example, a row deleted in the original table remains as an empty area in the table, and is used as an empty area of the table when a next row is inserted. FIG. 16 illustrates an example where a row “2” of an original table 2100 is deleted, and a row “3” is added.

However, the row deleted from the original table 2100 is marked as a deleted row by Delete Vector in a column store 2300, and remains. In, for example, FIG. 16, Delete Vector “1” is set to the row “2” of a column segment 2400-1 of the column store 2300.

Hence, an insertion order and an arrangement on the disk do not match. When only INSERT is carried out, row arrangements in the original table 2100 and the column store 2300 may be the same. However, when UPDATE and DELETE are carried out, too, the arrangement in the table 2100 and the arrangement column store 2300 do not match. Hence, the order of the original table 2100 and the order in the column store 2300 do not match.

This means that an index for a search (referred to as a “normal index” below) which is not a column store index in the original table of the row-oriented database is not applicable to the column store.

The row-oriented database provides a higher speed access to a specific row in the table by using a normal index. The normal index generally keeps a position of the original table as a value by using a designated column as a key. FIG. 17 illustrates a relationship between an original table 3100 and a normal index 3200.

The original table 3100 has a table including three columns of “ColA”, “ColB” and “ColC”, and the normal index 3200 is sorted in “ColA”. The normal index 3200 holds data by being sorted in “ColA”. In this regard, in an example in FIG. 17, the normal index 3200 is illustrated in a table format yet actually adopts a tree structure in many cases. “0:1” and “0:2” in the original table 3100 are identifiers indicating row positions in the table. This identifier will be referred to as a “record Identifier (ID)” below.

However, as described above, it is not ensured that row arrangement orders of the original table and the column store match. Therefore, as illustrated in FIG. 18, a normal index 4200 provided for an original table 4100 is unable to be directly mapped on a column store 4300. In other words, the normal index 4200 is unable to be used to scan the column store 4300.

When there is not index used for searching in the columnar, too, it is not possible to exhibit sufficient performance. Hence, it is considered to provide an index for a column store index in addition to a normal index of the original table to increase the performance of the column store index. However, this means that data is doubly held and a disk volume is wasted.

As described above, when the column-oriented column store is applied to improve processing performance of the row-oriented database, indices are provided to the column store, too, in addition to the normal indices, and use efficiency lowers from viewpoints of data compression and an update frequency in some cases.

### SUMMARY

According to an aspect of the embodiment, an information processing system may include: a storage device configured to store a row-oriented database and a column-oriented database converted from the row-oriented database; and a control device configured to control the storage device. The control device may include a converter configured to group a plurality of records included in the row-oriented database into a plurality of groups, and convert each of the groups into a column group conforming to a format of the column-oriented database.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a data configuration example of an original table including a visibility block map (VBM);

FIG. 2 is a view illustrating a data configuration example of a database according to one embodiment;

FIG. 3 is a block diagram illustrating a configuration example of an information processing system according to one embodiment;

FIG. 4 is a view illustrating an example of a conversion process of converting an original table into a column store;

FIG. 5 is a view illustrating an example of a reference process of scanning the original table without using a normal index;

FIG. 6 is a view illustrating an example of the reference process of scanning the original table by using the normal index;

FIG. 7 is a view illustrating a modified example of a reference process of scanning the original table by using a normal index;

FIG. 8 is a flowchart for explaining an example of a process of an update unit illustrated in FIG. 3;

FIG. 9 is a flowchart for explaining an example of a process of a converter illustrated in FIG. 3;

FIG. 10 is a flowchart for explaining an example of the conversion process illustrated in FIG. 9;

FIG. 11 is a flowchart for explaining an example of a process in case where a reference unit illustrated in FIG. 3 does not use a normal index;

FIG. 12 is a flowchart for explaining an example of a process in case where the reference unit illustrated in FIG. 3 uses a normal index;

FIG. 13 is a flowchart for explaining a modified example of a process in case where the reference unit illustrated in FIG. 3 uses a normal index;

FIG. 14 is a block diagram illustrating a hardware configuration example of a controller illustrated in FIG. 3;

FIG. 15 is a view illustrating an example of a relationship between an original table, a delta store and a column segment;

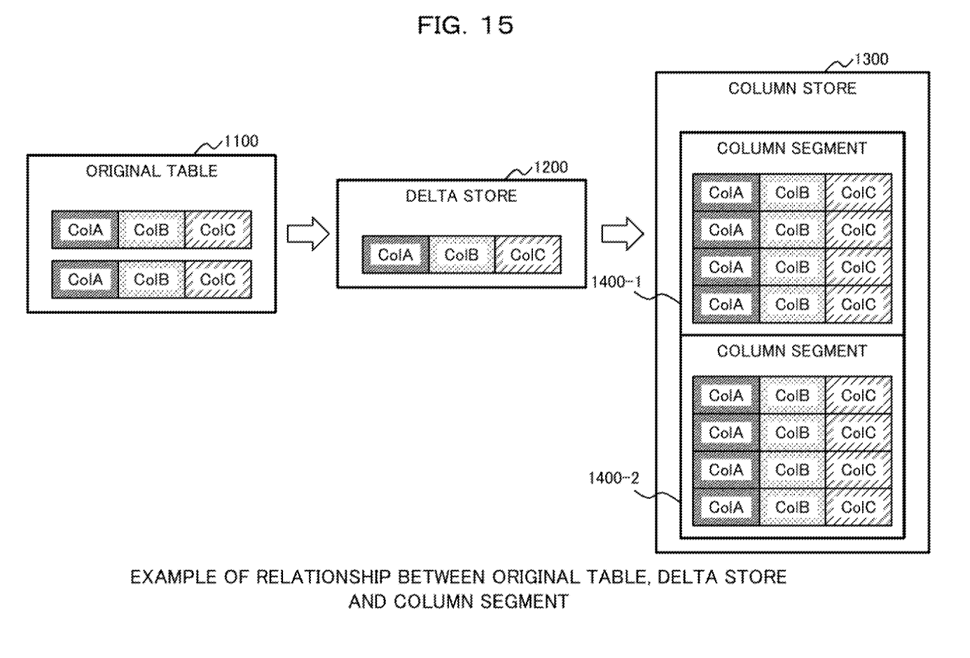

FIG. 16 is a view illustrating an example of a data change of the original table and the column store in case where a row is inserted and deleted;

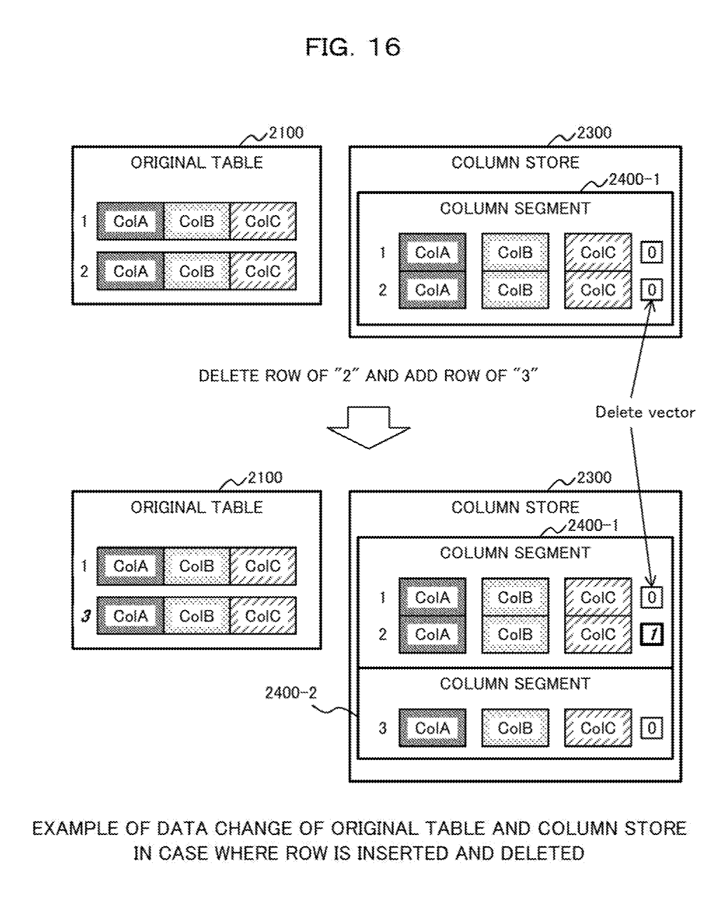

FIG. 17 is a view illustrating an example of a relationship between the original table and the normal index; and

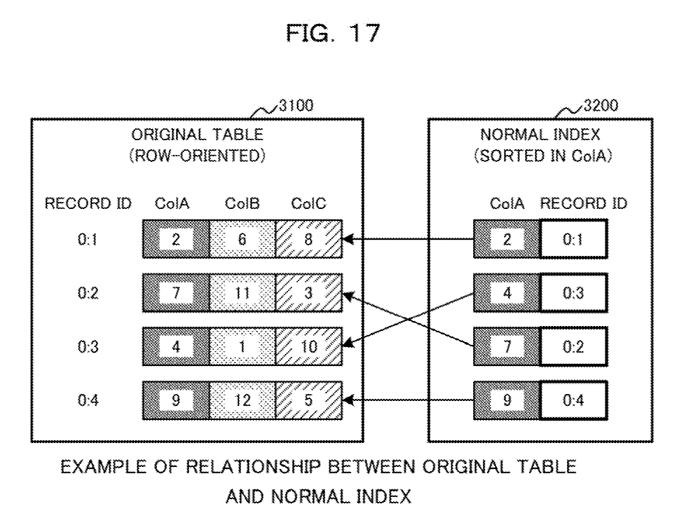

FIG. 18 is a view illustrating an example of a relationship between the original table, the normal index and the column store.

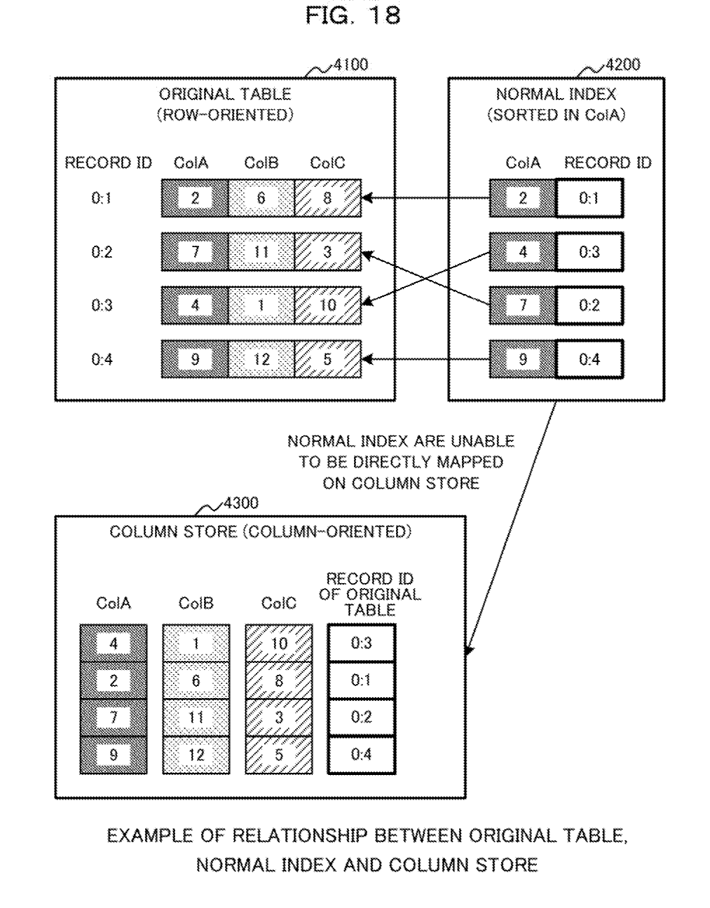

### DESCRIPTION OF EMBODIMENTS

An embodiment of the present invention will be described below with reference to the drawings. In this regard, the embodiment described below is an exemplary embodiment, and does not intend to exclude various modifications and application of techniques which are not explicitly described below. For example, the present embodiment can be variously modified and carried out without departing from the scope of the present embodiment. In this regard, components assigned the same reference numerals in the drawings used in the following embodiment indicate the same or similar components unless described in particular.

### [1] One Embodiment

### [1-1] Database Structure

A system according to one embodiment keeps coherence between an arrangement of a column store index and an arrangement of an original table, and enables application of a normal index of the original table to the column store index.

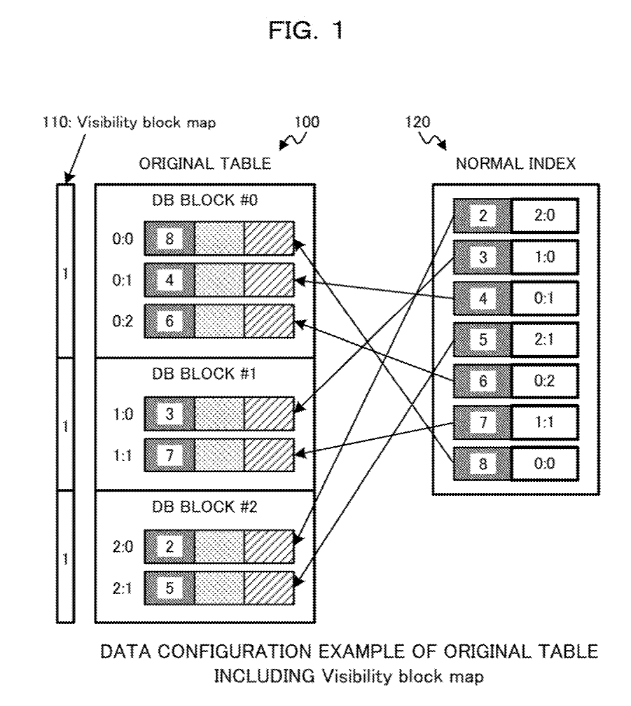

FIG. 1 illustrates a data configuration example of an original table 100 according to a comparative example. The original table 100 is divided in data units called DB blocks or DB pages (described as DB blocks #0 to #2 in FIG. 1). One DB block has a size of approximately 4 KB (bytes) to 64 KB, and is a unit of data loading from storage to a memory. In this regard, the DB block will be also referred to simply as a “block” below in the following description.

A plurality of records (rows) is stored in one DB block. The records stored in the table 100 can be indicated by block numbers and relative positions (e.g., “0:0”, “0:1” and “1:1”) in blocks. The relative position used as an identifier will be described as a record ID. A value on a left side of a colon (:) in a record ID indicates a DB block number, and a value on a right side of the colon indicates a relative position of the record in the DB block.

The original table 100 includes a visibility block map (VBM) 110. When a record in the original table 100 is changed, visibility of this change is controlled by a transaction model, and how the change looks differs according to the transaction. However, the visibility is ensured after all of other transactions which coexist with the transaction which changes the record are committed or aborted.

The VBM 110 is information for managing the visibility of each DB block, and may be managed as, for example, a bitmap in which one bit is allocated per DB block. For example, a state where visibility of all records in a DB block corresponding to a given bit is ensured is “1” as a value of the given bit of the VBM 110, and a state where there is even one record whose visibility is not ensured is “0”.

When a record in a block is changed, a bit at a position of the block of the VBM 100 lowers to “0”. Meanwhile, when scanning the original table 100 in an asynchronous manner and checking that visibility of all records in the block is ensured, the system performs a process of setting “1” to the VBM 110.

A normal index 120 sorts and stores a designated column. In an example in FIG. 1, the normal index 120 holds information obtained by sorting a leftmost column “ColA” of the original table 100. Further, the normal index 120 records data of the designated column and a record ID as a pair, and is a pointer for the original table 100. In the example in FIG. 1, the normal index 120 is illustrated as a table format yet may adopt a tree structure or a hash structure.

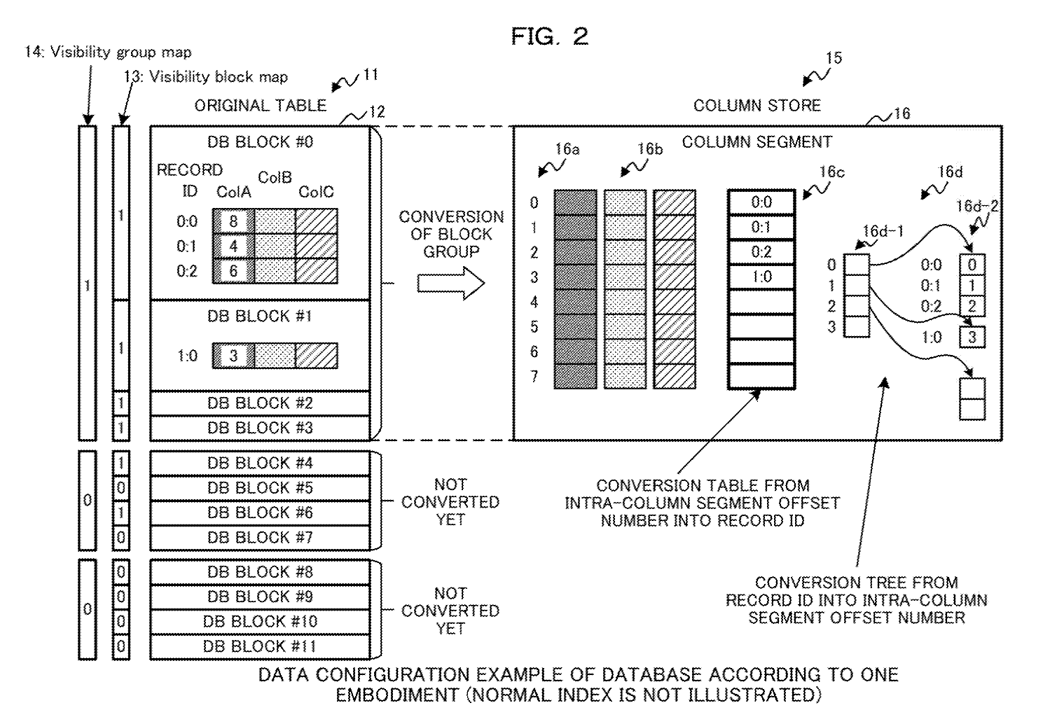

FIG. 2 is a view illustrating a database configuration example which is an example of one embodiment. In this regard, the normal index is not illustrated in the example in FIG. 2. However, the database according to one embodiment may include the normal index, too. The database according to one embodiment may be realized by a framework illustrated in FIG. 2.

An original table 11 is an example of a row-oriented database. The original table 11 may include a plurality of DB blocks 12 similar to FIG. 1. Further, a VBM 13 and a visibility group map (VGM) 14 may be set to the original table 11 similar to FIG. 1. The VBM 13 will be also referred to as the “block map 13” and the VGM 14 will be also referred to as the “group map 14” below in some cases.

The VGM 14 is information for managing visibility of the DB blocks 12 which are converted at a time. The DB blocks 12 which are converted at a time will be referred to as a block group. The system converts one block group obtained by collecting a fixed number of the DB blocks 12 of the original table 11 into one column segment 16.

The VGM 14 may be managed as, for example, a bitmap in which one bit is allocated per block group. For example, “1” is set to a value of a given bit of the VGM 14 when all block maps 13 in the block group corresponding to the given bit in the original table 11 is “1”, and “0” is set to the value of the given bit in other cases (when even one block map 13 is “0”).

When a record in the DB block 12 in the block group is changed, a bit at the position of the block group in the VGM 14 decreases to “0”. Meanwhile, the system performs an asynchronous process of setting “1” to the VGM 14 in an asynchronous manner with the original table 11. Further, when the asynchronous process sets “1” to all VBMs 13 in the DB blocks 12 of the same block group (visibility is ensured), the system converts the block group into the column segment 16, and sets “1” to a corresponding bit of the VGM 14.

Furthermore, the column segment 16 whose bit is set to “0” is invalidated in the VGM 14, and is not converted until the bit is set to “1” next time. By this means, when there is even one DB block 12 whose visibility is not ensured in the block group, the column segment 16 corresponding to this block group is invalidated. In this case, an access to this block group is made to the original table 11 instead of a column store index (referred to as a “column store 15” in FIG. 2).

In other words, the VGM 14 is an example of group information indicating whether or not the column segment 16 corresponding to each block group is valid. According to the VGM 14, the system can easily determine whether or not the column segment 16 is valid, and easily determine whether or not to convert a block group into the column segment 16.

Thus, according to one embodiment, when visibility of all DB blocks 12 in the block group is ensured, and when, for example, all coexisting transactions are committed or aborted, conversion into the column segment 16 is performed. In other words, in the block group in which “1” is set to the VGM 14, there is no mismatch between records due to deletion, insertion and update between the original table 11 and the column store 15, and match of arrangement orders is ensured.

As described above, according to one embodiment, the original table 11 is converted into the column segment 16 in block group units including a plurality of DB blocks 12. Consequently, there is data in block group units whose match with the arrangement order of the original table 11 is ensured in the column segment 16, so that it is possible to use the normal index for both of the original table 11 and the column store 15.

Further, a block group which is large to some degree increases the number of rows to be converted at a time, and enhances a compression effect. Furthermore, there is stationary cost for one conversion into the column segment 16. Hence, converting multiple rows at a time is relatively less costly. For example, the block group may be approximately one MiB (mebibyte). When, for example, one DB block is 4 KiB (kibibyte) to 64 KiB, one block group may include 16384 to 262144 DB blocks. In this regard, four DB blocks will be collectively regarded as one block group below for simplification of the drawings.

The column store 15 is an example of a column-oriented database converted from the original table 11. The column store 15 may store the column segment 16 per block group. The column segment 16 is an example of a column group corresponding to the block group of the original table 11.

As illustrated in FIG. 2, the column segment 16 may be associated with data 16b of a column segment, and, in addition, an intra-column segment offset number 16a, a conversion table 16c and a conversion tree 16d.

The intra-column segment offset number 16a is information indicating an offset number of the data 16b.

The conversion table 16c is information for converting the intra-column segment offset number 16a into a record ID of the original table 11. The conversion table 16c may record a record ID for specifying which record of the original table 11 the data 16b in the column store 15 corresponds to.

In other words, the conversion table 16c is an example of information indicating a relationship with identification information of a corresponding record in a converted group for each data in a column group generated by conversion.

The conversion tree 16d is information for converting a record ID into an intra-column segment offset number 16a, and may include data for recording a record ID to a position of the column store 15.

The conversion tree 16d may adopt a hierarchical structure which combines a table 16d-1 of a first stage for searching for a DB block number of a record ID, and a table 16d-2 of a second stage for extracting a record ID based on a relative position below a specific block number. In this regard, a hash table other than a tree structure may be used for the data structure of the conversion tree 16d.

In other words, the conversion tree 16d is an example of relationship information indicating a relationship between identification information of each record in a converted group, and a relative position of data corresponding to this record in a column group generated by conversion.

In an example in FIG. 2, a DB block number (indicating “0” to “3” in FIG. 2) of a record ID and a pointer to the table 16d-2 (indicated by square frames from which arrows travel toward the table 16d-2 in FIG. 2) may be set to the table 16d-1.

Further, in the example in FIG. 2, a relative position of a record ID (a value on a right side of a colon indicating an entire record ID in FIG. 2) and the intra-column segment offset number 16a (indicated by a number in a square frame in FIG. 2) may be set to the table 16d-2.

### [1-2] Configuration Example of Information Processing System

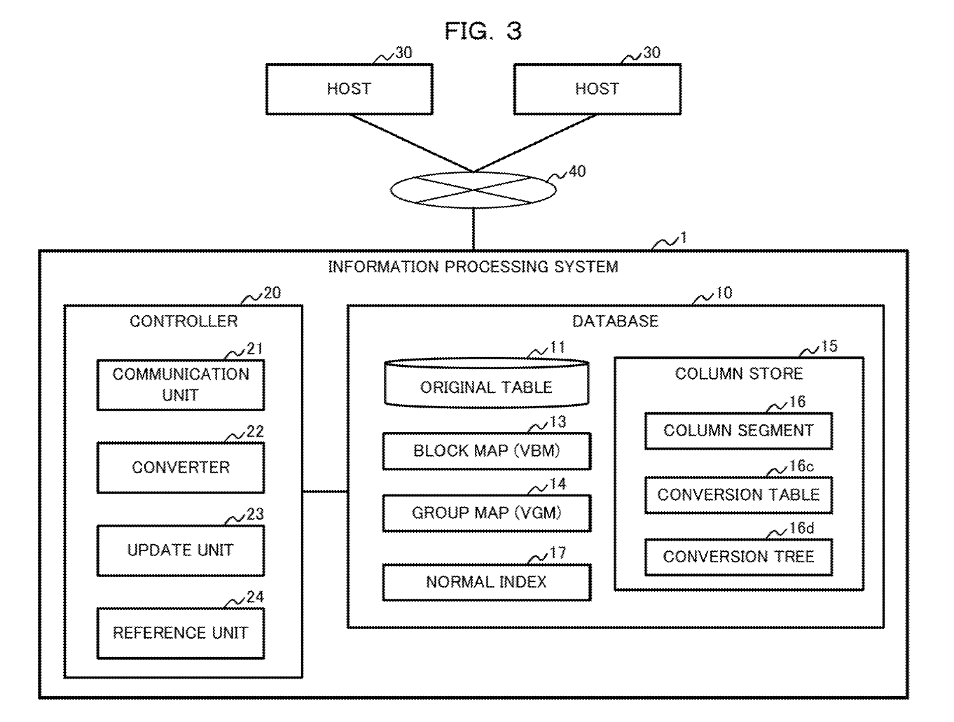

Next, a configuration example of an information processing system 1 according to one embodiment will be described. FIG. 3 is a view illustrating a functional configuration example of the information processing system 1 according to one embodiment.

As illustrated in FIG. 3, the information processing system 1 may illustratively include a database 10 and a controller 20.

The database 10 is an example of a storage device which stores a row-oriented database and a column-oriented database. The database 10 may adopt a data structure illustrated in FIG. 2. For example, the database 10 stores the original table 11, the block map (VBM) 13, the group map (VGM) 14, the column store 15 and a normal index 17.

In this regard, the column store 15 may include the column segment 16 including the intra-column segment offset number 16a and the data 16b, the conversion table 16c and the conversion tree 16d as described with reference to FIG. 2.

The database 10 may be realized by one or more storages, and a plurality of storages may configure a disk array such as a RAID (Redundant Arrays of Inexpensive Disks). The storage is, for example, a magnetic disk device such as a HDD (Hard Disk Drive), a semiconductor drive device such as a SSD (Solid State Drive), and a non-volatile memory. The non-volatile memory is, for example, a flash memory, a SCM (Storage Class Memory) and a ROM (Read Only Memory).

The controller 20 is an example of a control device or a computer which performs various types of control on the database 10. When, for example, receiving an operation request such as reference or update from a host 30 to the database via a network 40, the controller 20 performs an operation of referring to or updating the database 10 and returns a response to the host 30.

Thus, the information processing system 1 may provide functions and services of a database management system to the host 30.

In this regard, the host 30 is, for example, a computer such as a business server, a basic server or a client machine. FIG. 3 illustrates the two hosts 30. However, the number of the hosts 30 may be one or three or more.

The network 40 is, for example, the Internet, a local area network (LAN) or a wide area network (WAN).

The controller 20 may illustratively include a communication unit 21, a converter 22, an update unit 23 and a reference unit 24.

The communication unit 21 performs communication with the hosts 30. For example, the communication unit 21 receives operation requests from the hosts 30, delivers the operation requests to the update unit 23 or the reference unit 24, and transmits operation results from the update unit 23 or the reference unit 24 to the hosts 30.

The converter 22 groups a plurality of records included in the original table 11, into a plurality of block groups, and converts each block group into the column segment 16 conforming to a format of the column store 15 per block group.

Further, when updating all of a plurality of records in a group of the invalid column segment 16 is ensured, in other words, when visibility of all records is ensured, the converter 22 converts a group for which the update is ensured into the column segment 16. Furthermore, the converter 22 performs a process of setting to the group map 14 that the converted column segment 16 is valid. The converter 22 may perform a process in an asynchronous manner with a process performed on the database 10 by the update unit 23 and the reference unit 24.

The converter 22 may perform the process according to, for example, the following procedure.

(A) The converter 22 determines whether or not visibility of all records in the DB block 12 (see FIG. 2) to which “0” has been set is ensured in a block group in which “0” is set to the group map 14.

(B) When the visibility of all records is ensured in (A), the converter 22 sets “1” to the block map 13 at the position of the DB block 12.

(C) When “1” is set to all block maps 13 in the block group as a result of (A) and (B), the converter 22 converts the block group into the column segment 16.

(D) The converter 22 sets “1” to the group map 14 at a position of the block group.

(E) The converter 22 performs (A) to (D) on another block group in which “0” is set to the group map 14.

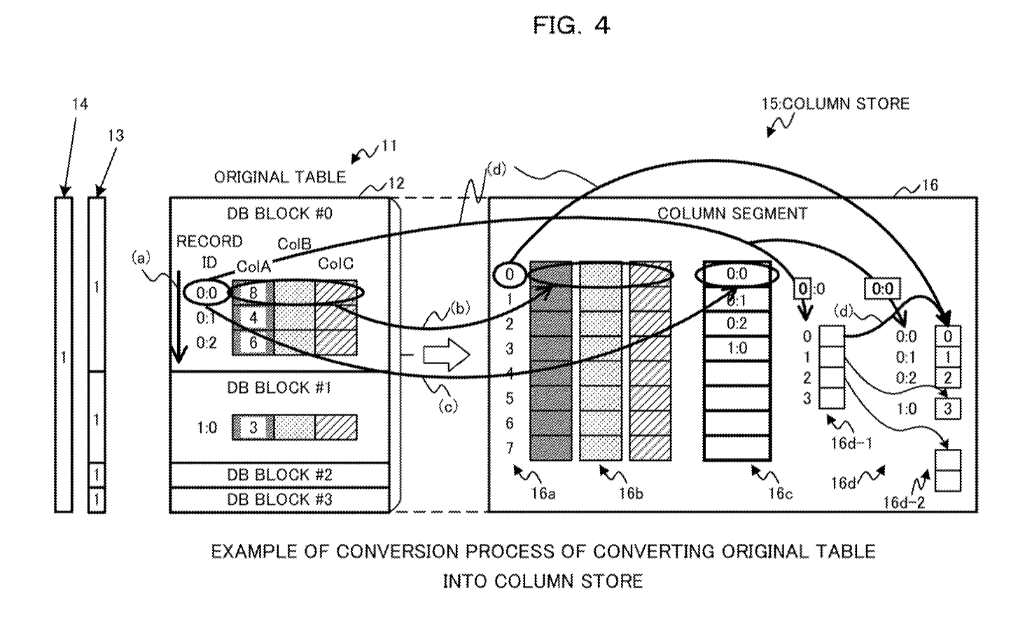

A conversion process in (C) may be performed according to the following procedure as illustrated in FIG. 4. In this regard, FIG. 4 illustrates processes corresponding to following (a) to (d) as arrows with reference numerals.

(a) The converter 22 reads one DB block 12 from a block group to be converted, and scans a record from this DB block 12.

(b) The converter 22 adds data of each column of one record to the data 16b at a position of the predetermined intra-column segment offset number 16a of the column segment 16.

(c) The converter 22 adds a record ID of one record to the conversion table 16c.

(d) The converter 22 adds a correspondence between the record ID of one record and the intra-column segment offset number 16a to the conversion tree 16d. During this process, a process of associating a pointer to the table 16d-2 with a DB block number of a record ID and setting the pointer to the table 16d-1, and a process of associating the intra-column segment offset number 16a with the record ID and setting the intra-column segment offset number 16a to the table 16d-2 are performed.

(e) The converter 22 increments the intra-column segment offset number 16a, and performs (b) to (d) on another record.

(f) The converter 22 performs (a) to (e) on another DB block 12 in a block group to be converted.

According to the above procedure, the converter 22 converts the original table 11 into the column segment 16 in block group units including a plurality of DB blocks 12, and sets the column segment 16 to the column store 15. Consequently, there is data in block group units whose arrangement order is ensured to match with that of the original table 11, so that it is possible to use the same normal index for both of the original table 11 and the column store 15. Further, conversion in block group units can reduce conversion cost while increasing compression efficiency. Consequently, it is possible to improve both of database processing performance and use efficiency.

The update unit 23 performs various update processes such as INSERT/DELETE/UPDATE on the original table 11 in response to an updating operation request received from the communication unit 21. Hence, the update unit 23 may include an execution engine which performs an updating operation. Alternatively, the update unit 23 does not need to include the execution engine, and may include a function of making an operation request to the execution engine instead.

Further, the update unit 23 performs a process of clearing a value of a bit position related to the updating operation of the block map 13 and the group map 14 to “0” at a timing at which an operation of updating the original table 11 is performed. Thus, the column segment 16 corresponding to a portion updated in the original table 11 is invalidated. The DB block 12 is updated, and therefore it is not possible to ensure match of arrangement orders of the DB block 12 and the column segment 16.

Thus, the update unit 23 invalidates the column segment 16, so that the converter 22 can convert the latest record into the column segment 16 after updating a record related to the update is ensured, and update the column store 15 to the latest state.

In other words, the update unit 23 is an example of an invalidating unit which sets to the group information that a column group of a group including records to be updated in the row-oriented database is invalid.

The reference unit 24 is an example of a reader. The reference unit 24 performs various reference processes such as SELECT on the original table 11 or the column store 15 in response to a reference operation request (query: reference request) to the original table 11 received from the communication unit 21. Hence, the reference unit 24 may include a query execution engine which performs a reference operation. Alternatively, the reference unit 24 does not need to include the query execution engine, and may include a function of making an operation request to the query execution engine instead.

In this case, the reference unit 24 determines a reading target of a reference target record from one of the original table 11 and the column store 15 based on the group map 14 in block group units in which there is the reference target record. Further, the reference unit 24 reads the record designated by the operation request from the determined reading target.

For example, the reference unit 24 determines to scan the original table 11 when a value of the group map 14 corresponding to a block group for which a query is made is “0”. Meanwhile, the reference unit 24 determines that data is supplied from the column store 15 instead of the original table 11 when the value of the group map 14 is “1”.

In this regard, the reference unit 24 uses the normal index 17 in some cases and does not use the normal index 17 in some cases during execution of the query.

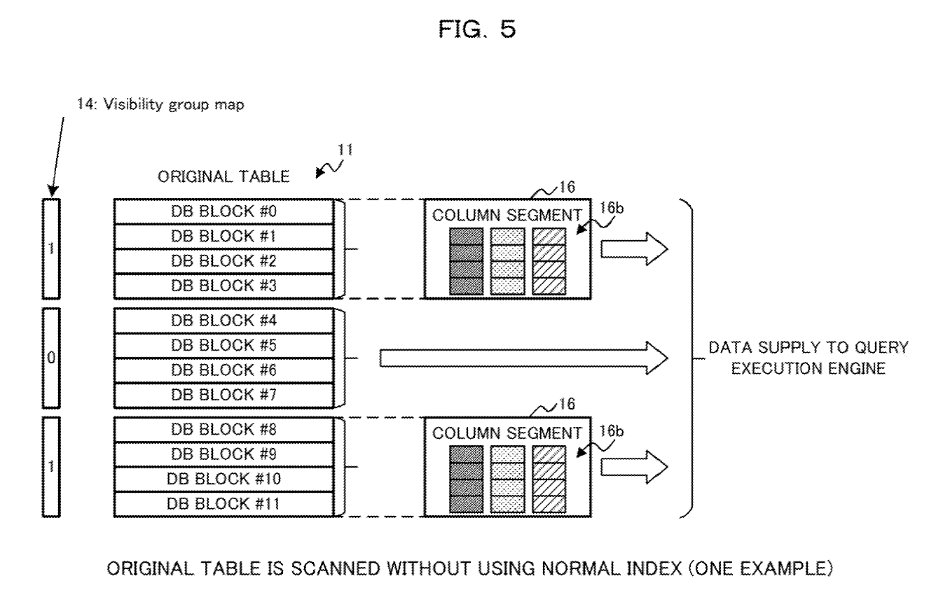

When the original table 11 is directly scanned without the normal index 17 during execution of the query, the reference unit 24 performs the following process (I) or (II) as illustrated in FIG. 5. In this regard, FIG. 5 does not illustrate the block map 13.

(I) When the group map 14 of a reference target block group is “0”: the reference unit 24 scans the reference target DB block 12 from the original table 11, and reads data of a record (see a block group of DB blocks #4 to #7 in FIG. 5). The read data is supplied to the query execution engine.

(II) When the group map 14 of the reference target block group is “1”: the reference unit 24 scans the reference target DB block 12 from the column store 15, and reads data of a record (see each block group of DB blocks #0 to #3 and DB blocks #8 to #11 in FIG. 5). The read data is supplied to the query execution engine. In this regard, it may be unnecessary to refer to the conversion table 16c and the conversion tree 16d to scan the column store 15.

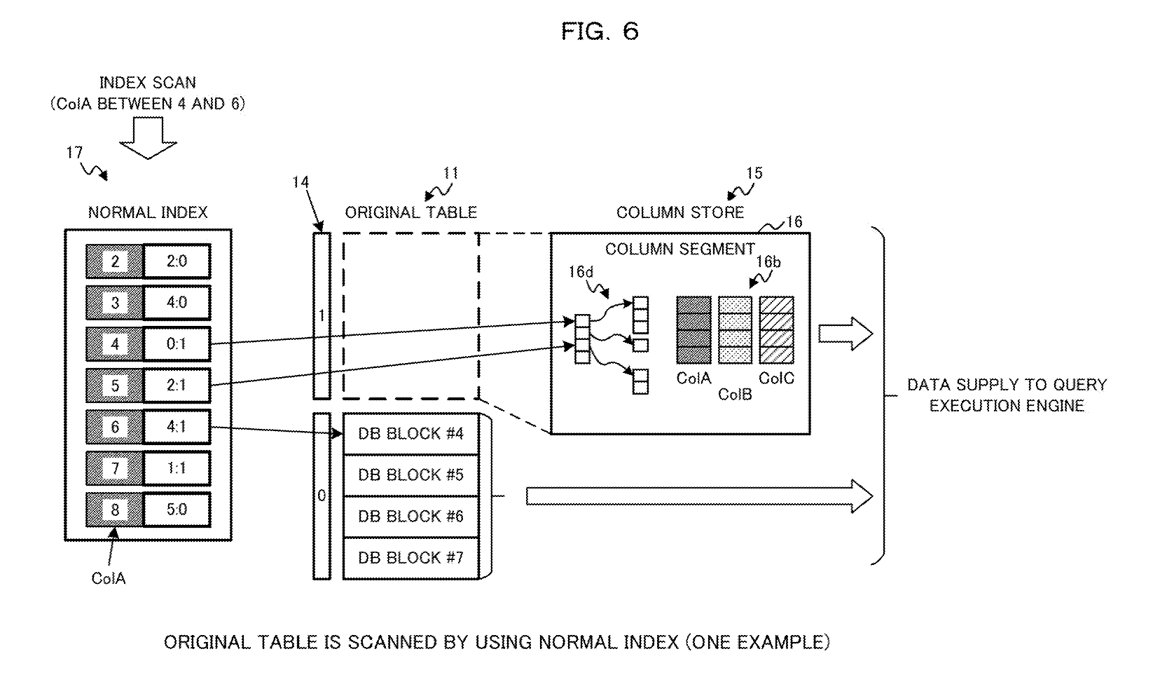

Next, a case where the normal index 17 is used and searched in the original table 11 during query execution will be described. For example, the original table 11 includes three columns of “ColA”, “ColB” and “ColC”, and the normal index 17 of “ColA” is created. Then, when a query such as “SELECT ColB FROM ORIGINAL TABLE WHERE ColA BETWEEN 4 AND 6” is executed, the reference unit 24 performs the following processes (i) to (iv) as illustrated in FIG. 6.

(i) The reference unit 24 scans the normal index 17 under a condition “ColA BETWEEN 4 AND 6” designated by a “WHERE” phrase to extract a record ID of a row matching the condition.

(ii) Since the record ID includes a DB block number, the reference unit 24 identifies a block group by the DB block number to determine whether or not there is data of the record in the column store 15 with reference to the group map 14.

(iii) When there is the data of the record in the column store 15 in (ii) (see a block group in which the value of the group map 14 in FIG. 6 is “1”), the reference unit 24 refers to the column segment 16.

Further, the reference unit 24 refers to the conversion tree 16d “from the record ID to the intra-column segment offset number 16a” in the column segment 16, identifies the data of the record corresponding to a key of the normal index 17, and supplies data to the query execution engine.

(iv) When there is not the data of the record in the column store 15 in (ii) (see a block group of the DB blocks #4 to #7 in FIG. 6), the reference unit 24 refers to the original table 11. Further, the reference unit 24 identifies the data of the record corresponding to the key of the normal index 17 from the original table 11, and supplies data to the query execution engine.

Thus, the reference unit 24 may specify a record designated by a reference request by using the normal index 17 set to the original table 11. Further, when a reading target is the column store 15, the reference unit 24 may specify a relative position of data in the column segment 16 corresponding to the record specified by using the normal index 17 based on the conversion tree 16d.

In this regard, when information requested by the query includes a record ID, the reference unit 24 may refer to the conversion table 16c and obtain the record ID corresponding to the intra-column segment offset number 16a. Consequently, it is possible to respond to the record ID by using the column segment 16.

### [1-2-1] Modified Example of Reference Unit

In this regard, the reference unit 24 may apply a bitmap filter to a query which uses bitmap scan to more efficiently use the normal index 17 during query execution. Such a bitmap filter is, for example, a bitmap filter mounted on SQL Server of Microsoft (registered trademark) or Bitmap Heap Scan of PostgreSQL.

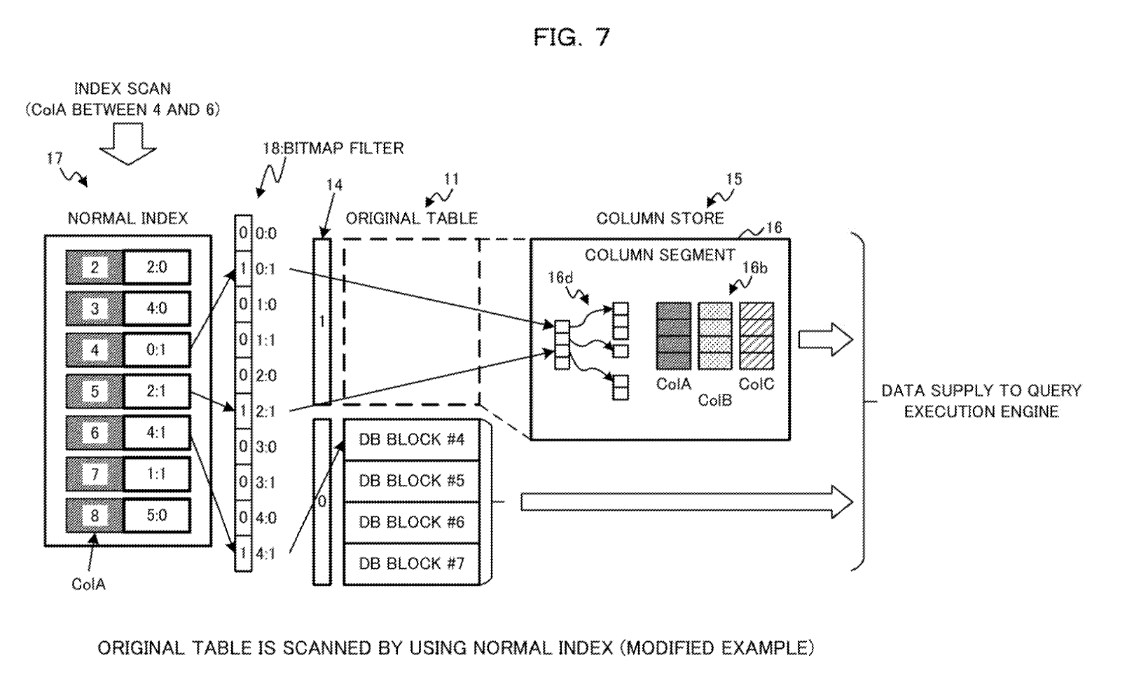

For example, the reference unit 24 may perform the following processes (ii′-1) and (ii′-2) instead of the process (ii) as illustrated in FIG. 7. The reference unit 24 may perform determination in (ii′-2) and perform the process (iii) or (iv).

(ii′-1) The reference unit 24 records a row matching search for the normal index 17 in a bitmap (described as a “bitmap filter 18” in FIG. 7) arranged in an order of record IDs. For example, the reference unit 24 sets “1” to a bit of the row matching the search, and sets “0” to other bits.

(ii′-2) The reference unit 24 searches the bitmap filter 18 in order of record IDs, and determines whether or not there is data of the record in the column store 15 for a record ID corresponding to a position to which “1” has been set.

Thus, the reference unit 24 may set the record specified by using the normal index 17, to the bitmap filter 18 arranged in order of record identification information. Further, the reference unit 24 may determine a reading target in order of the record identification information for records set to the bitmap filter 18.

By using the bitmap filter 18, the bitmap is arranged in order of record IDs, so that the reference unit 24 can collectively obtain whether or not a row belonging to the same block group has been selected. By performing the processes (ii′-2) and (iii), the reference unit 24 can make a sequential access to the column segment 16, so that it is possible to efficiently execute a query and improve a throughput. The bitmap filter 18 will be also described simply as the “bitmap 18” below.

### [1-3] Operation Example

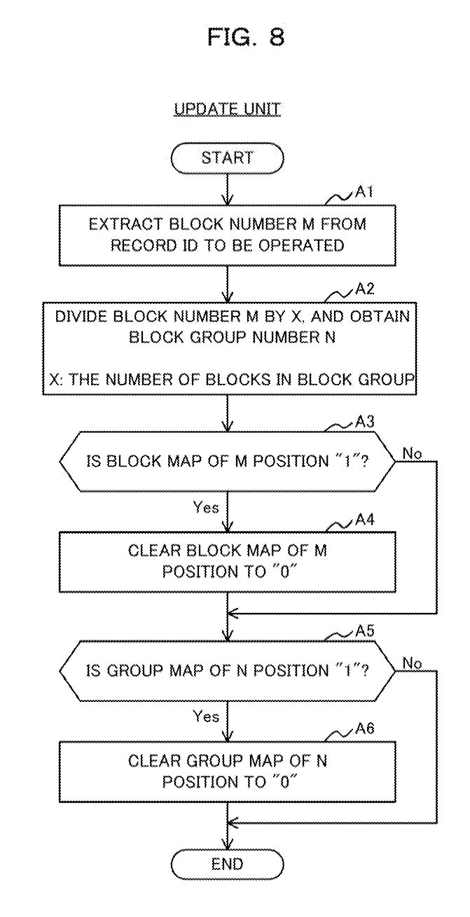

Next, an operation example of the information processing system 1 configured as described above will be described with reference to FIGS. 8 to 13.

### [1-3-1] Operation Example of Update Unit

The update unit 23 receives an updating operation request that the communication unit 21 received from the host 30, from the communication unit 21.

When receiving the operation request, the update unit 23 may perform an operation related to the request on original table 11 by using an execution engine which performs the updating operation. Further, when finishing the updating operation, the update unit 23 may perform a process of updating the block map 13 and the group map 14 illustrated in FIG. 8. In this regard, the update process may be performed in parallel to the updating operation or before the updating operation.

As illustrated in FIG. 8, the update unit 23 specifies a record ID of the operation target original table 11 from the operation request, and extracts a block number M (M is an integer) from the record ID (step A1).

Next, the update unit 23 divides the block number M by the number of blocks in a block group (the number of configuration blocks of the block group) X (X is an integer equal to or more than 2), and obtains a block group number N (N is an integer) (step A2). In this regard, to obtain a local block number in the block group, a remainder may be obtained by dividing the block number M by the number of configuration blocks X of the block group.

The update unit 23 determines whether or not the block map 13 at the position of M in the block group N is “1” (step A3). When the block map 13 is “1” is a result of determination (Yes in step A3), the update unit 23 clears the block map 13 at the position of M to “0” (step A4), and the process moves to step A5. Meanwhile, when the block map 13 is not “1” as the result of determination (No in step A3), the process moves to step A5.

In step A5, the update unit 23 determines whether or not the group map 14 at the position of the block group N is “1”. When the group map 14 is “1” as the result of determination (Yes in step A5), the update unit 23 clears the group map 14 at the position of N to “0” (step A6) and finishes the process. Meanwhile, when the group map 14 is not “1” as the result of determination (No in step A5), the update unit 23 finishes the process.

### [1-3-2] Operation Example of Converter

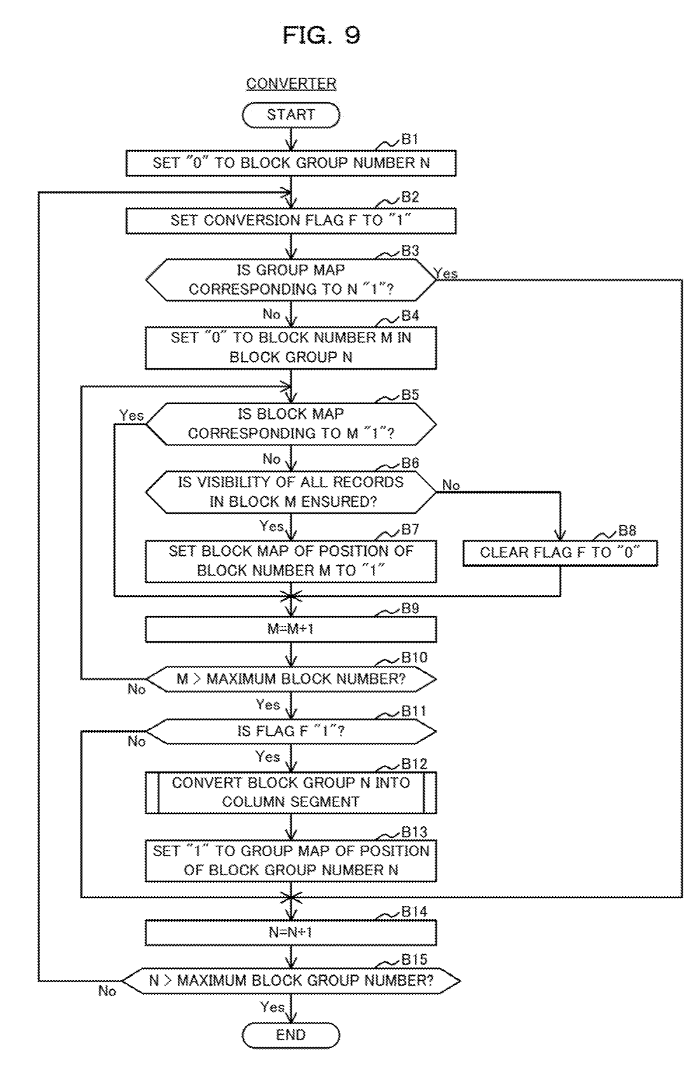

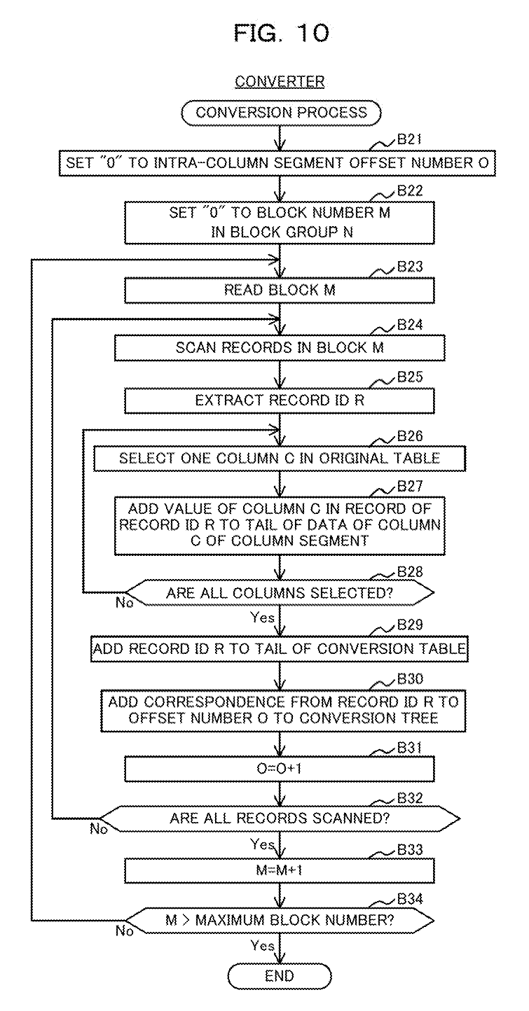

The converter 22 may perform a process of updating the block map 13 and the group map 14 and converting the original table 11 into the column store 15 illustrated in FIGS. 9 and 10 in an asynchronous manner with the processes of the update unit 23 and the reference unit 24.

As illustrated in FIG. 9, the converter 22 sets “0” to the block group number N (step B1). Further, the converter 22 sets the flag (conversion flag) F to “1” (step B2).

The converter 22 determines whether or not the group map 14 corresponding to the block group N is “1” (step B3). When the group map 14 is not “1” as a result of determination (No in step B3), the converter 22 sets “0” to the block number M in the block group N (step B4).

Further, the converter 22 determines whether or not the block map 13 corresponding to the block number M is “1” (step B5). When the block map 13 is not “1” as a result of determination (No in step B5), the converter 22 determines whether or not visibility of all records in the block M is ensured (step B6).

When the visibility of all records is ensured (Yes in step B6), the converter 22 sets the block map 13 at the position of the block number M to “1” (step B7), and the process moves to step B9.

Meanwhile, when the visibility of at least one record is not ensured (No in step B6), the converter 22 clears the flag F to “0” (step B8), and the process moves to step B9. In this regard, when the block map 13 corresponding to the block number M is “1” as a result of determination in step B5 (Yes in step B5), the process moves to step B9.

In step B9, the converter 22 adds 1 to M. Further, the converter 22 determines whether or not M exceeds a maximum block number (step B10). When M does not exceed the maximum block number (No in step B10), the process moves to step B5, and the converter 22 performs determination on the next block number M. Meanwhile, when M exceeds the maximum block number (Yes in step B10), the converter 22 determines whether or not the flag F is “1” (step B11).

When the flag F is not “1” as a result of determination (No in step B11), the process moves to step B14. Meanwhile, when the flag F is “1” as a result of determination (Yes in step B11), the converter 22 converts the block group N into the column segment 16 (step B12). This is because the visibility of all records in all blocks 12 in the block group N is ensured.

Further, the converter 22 sets “1” to the group map 14 at the position of the block group number N (step B13), and adds 1 to N (step B14). Furthermore, the converter 22 determines whether or not N exceeds a maximum block group number (step B15).

When N does not exceed the maximum block group number as a result of determination (No in step B15), the process moves to step B2, and the converter 22 performs determination on the next block group number N.

Meanwhile, when N exceeds the maximum block group number (Yes in step B15), the converter 22 finishes the process.

In this regard, when the group map 14 corresponding to the block group number N is “1” as the result of determination in step B3 (Yes in step B3), the process moves to step B14. That is, the column segment 16 has already been created, and therefore the converter 22 does not process the block group N any more, and performs determination on the next block group number.

Next, an operation example of a conversion process in step B12 in the converter 22 will be described with reference to FIG. 10.

The converter 22 sets “0” to the intra-column segment offset number O (O is an integer) (step B21), and sets “0” to the block number M in the block group N (step B22). In this regard, N is a value set when the process moves to step B12 in FIG. 9.

The converter 22 reads the block M (step B23). Further, the converter 22 scans records in the block M (step B24), and extracts a record ID R of the records (step B25).

Furthermore, the converter 22 selects one column C of the record in the original table 11 (step B26), and adds a value of the column C in the record of the record ID R to a tail of data of the column C of the column segment 16 (step B27).

The converter 22 determines whether or not all columns in the record have been selected (step B28), and, when all columns are not selected (No in step B28), the process moves to step B26, and the converter 22 selects the unselected column C.

Meanwhile, when all columns are selected as a result of determination (Yes in step B28), the converter 22 adds the record ID R to the tail of the conversion table 16c from the intra-column segment offset number 16a into the record ID (step B29). Further, the converter 22 adds a correspondence between the record ID R and the intra-column segment offset number O, to the conversion tree 16d from the record ID into the intra-column segment offset number 16a (step B30).

Furthermore, the converter 22 adds 1 to O (step B31), and determines whether or not all records in the block M have been scanned (step B32). When all records are not scanned (No in step B32), the process moves to step B24, and the converter 22 scans unscanned records.

Meanwhile, when all records are scanned (Yes in step B32), the converter 22 adds 1 to M (step B33), and determines whether or not M exceeds the maximum block number in the block group N (step B34).

When M does not exceed the maximum block number as a result of determination (No in step B34), the process moves to step B23, and the converter 22 performs determination on the next block 12. Meanwhile, when M exceeds the maximum block number (Yes in step B34), the converter 22 finishes the process.

### [1-3-3] Operation Example of Reference Unit

The reference unit 24 receives a reference operation request (e.g., query) received by the communication unit 21 from the host 30 from the communication unit 21.

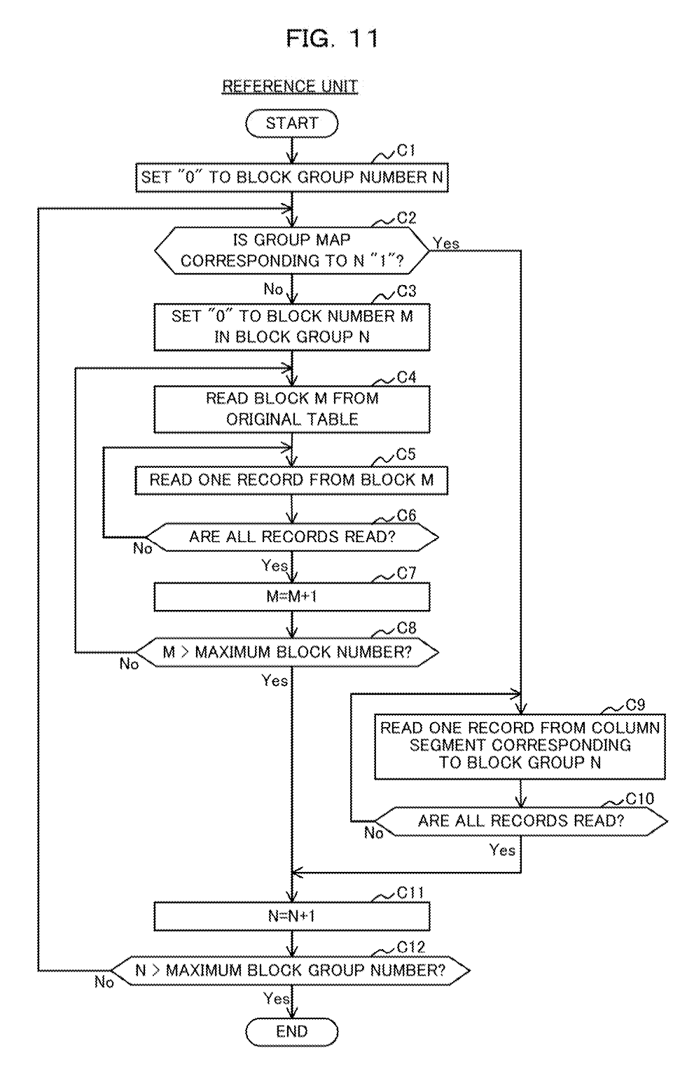

When receiving the query, the reference unit 24 may read data related to the query from the original table 11 or the column store 15 by using a query execution engine by one of methods in FIGS. 11 to 13.

(Inquiry (Query) without Normal Index)

In a case of an inequity (query) without a normal index, as illustrated in FIG. 11, the reference unit 24 sets “0” to the block group number N (step C1), and determines whether or not the group map 14 corresponding to the block group N is “1” (step C2).

When the group map 14 is not “1” as a result of determination (No in step C2), the reference unit 24 sets “0” to the block number M in the block group N (step C3), and reads the block M from the original table 11 (step C4).

Further, the reference unit 24 reads one record from the block M (step C5), and determines whether or not all records are read from the block M (step C6). When all records are not read (No in step C6), the process moves to step C5, and the reference unit 24 reads an unread record. Meanwhile, when all records are read (Yes in step C6), the reference unit 24 adds 1 to M (step C7), and determines whether or not M exceeds the maximum block number (step C8).

When M does not exceed the maximum block number in the block group N (No in step C8), the process moves to step C4, and reads the next block M from the original table 11. Meanwhile, when M exceeds the maximum block number (Yes in step C8), the process moves to step C11.

When the group map 14 corresponding to the block group N is “1” in step C2 (Yes in step C2), the reference unit 24 reads one record from the column segment 16 of the column store 15 corresponding to the block group N (step C9). Further, the reference unit 24 determines whether or not all records are read from the column segment 16 (step C10). When all records are not read (No in step C10), the process moves to step C9, and the reference unit 24 reads an unread record. Meanwhile, when all records are read (Yes in step C10), the process moves to step C11.

In step C11, the reference unit 24 adds 1 to N. Further, the reference unit 24 determines whether or not N exceeds the maximum block group number (step C12).

When N does not exceed the maximum block group number (No in step C12), the process moves to step C2, and the reference unit 24 performs determination on the next block group N. Meanwhile, when N exceeds the maximum block group number (Yes in step C12), the reference unit 24 finishes the process.

Thus, according to a determination result obtained by determining whether or not the group map 14 is “1” in step C2, in other words, according to a determination result obtained by determining whether or the column segment 16 is valid, a target from which a record is read is selected from the column segment 16 and the original table 11 (see FIG. 5).

In this regard, the record read in steps C5 and C9 may be stored and accumulated in, for example, a memory, may be read from the memory when all records of the query are read, and may be transmitted to the host 30 via the communication unit 21.

(Inquiry (Query) with Normal Index)

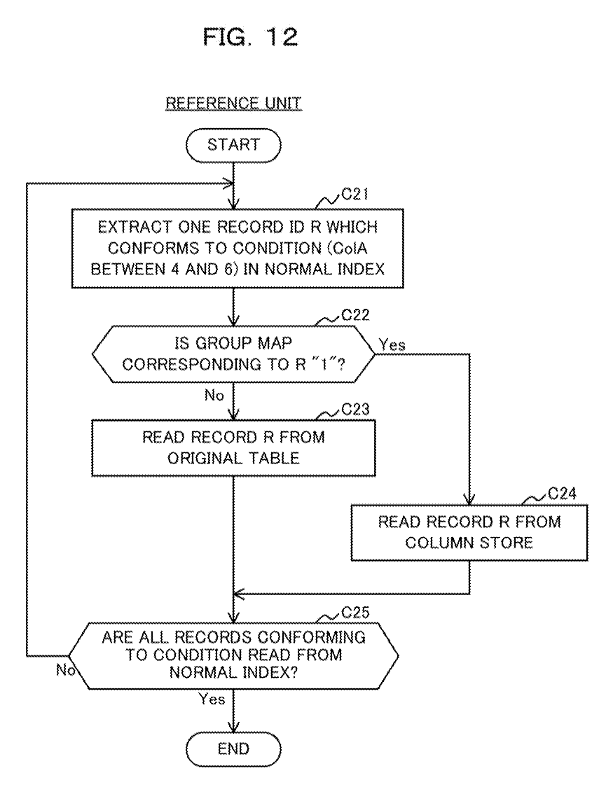

To perform searching by using the normal index 17, as illustrated in FIG. 12, the reference unit 24 extracts one record ID R conforming to a condition (e.g., “ColA BETWEEN 4 AND 6”) in the normal index 17 (step C21).

Further, the reference unit 24 determines whether or not the group map 14 corresponding to the record ID R is “1” (step C22).

When the group map 14 is not “1” (No in step C22), the reference unit 24 reads a record of the record ID R from the original table 11 (step C23), and the process moves to step C25. Meanwhile, when the group map 14 is “1” (Yes in step C22), the reference unit 24 reads the record of the record ID R from the column segment 16 of the column store 15 (step C24), and the process moves to step C25.

In step C25, the reference unit 24 determines whether or not to read all records conforming to the condition from the normal index 17. When all records are not read from the normal index 17 (No in step C25), the process moves to step C21 to extract one unread record ID R. Meanwhile, when all records are read from the normal index 17 (Yes in step C25), the process is finished.

By determining whether or not the column segment 16 is valid per record read from the normal index 17 in this way, a record reading target is selected from the column segment 16 and the original table 11 (see FIG. 6).

(Modified Example of Inquiry (Query) with Normal Index)

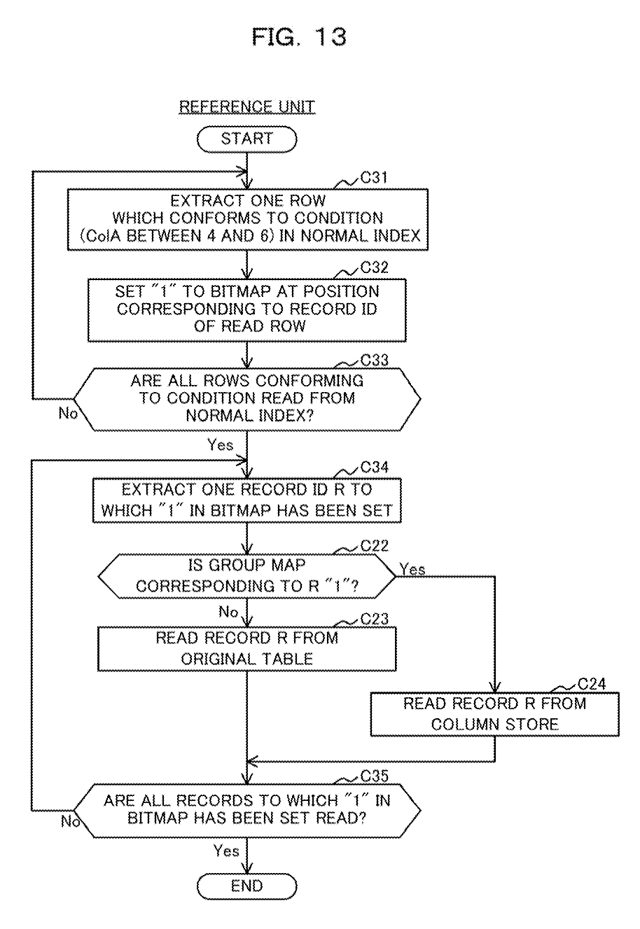

Next, use of the bitmap filter 18 illustrated in FIG. 7 will be described as a modified example of search performed by using the normal index 17 with reference to FIG. 13. FIG. 13 illustrates that step C21 in FIG. 12 is replaced with steps C31 to C34, and step C25 in FIG. 12 is replaced with step C35.

As illustrated in FIG. 13, the reference unit 24 reads one row conforming to the condition (e.g., “ColA BETWEEN 4 AND 6”) in the normal index 17 (step C31). Further, the reference unit 24 sets “1” to the bitmap 18 at a position corresponding to the record ID of a row read from the normal index 17 (step C32).

The reference unit 24 determines whether or not all records conforming to the condition are read from the normal index 17 (step C33). When all records are not read from the normal index 17 (No in step C33), the process moves to step C31, and the reference unit 24 reads one unread row in the normal index 17 conforming to the condition.

Meanwhile, when all records are read from the normal index 17 (Yes in step C33), the reference unit 24 extracts one record ID R to which “1” in the bitmap 18 has been set (step C34).

Further, the reference unit 24 determines whether or not the group map 14 corresponding to the record ID R is “1”, and reads a record of a record ID R from the original table 11 or the column segment 16 according to the value of the group map 14. These processes are the same as those in steps C22 to C24 in FIG. 12.

When reading a record from the original table 11 or the column segment 16, the reference unit 24 determines whether or not all records to which “1” in the bitmap 18 has been set are read (step C35).

When all records are not read (No in step C35), the process moves to step C34, and the reference unit 24 extracts one unread record ID R to which “1” in the bitmap 18 has been set. Meanwhile, when all records are read (Yes in step C35), the process is finished.

### [1-4] Hardware Configuration Example

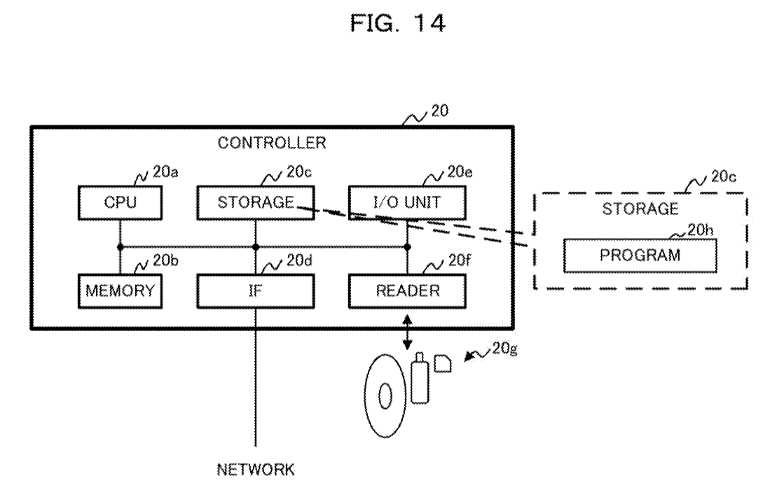

Next, a hardware configuration example of the information processing system 1 will be described. As illustrated in FIG. 14, the controller 20 may illustratively include a CPU 20a, a memory 20b, a storage 20c, an interface (IF) 20d, an I/O unit 20e and a reader 20f.

The CPU 20a is an example of a processor or an arithmetic operation processing device which performs various types of control and arithmetic operations. The CPU 20a is not connected with each block in the controller 20 by a bus and can communicate with each block. For example, an integrated circuit such as a MPU, a DSP, an ASIC and a FPGA may be used as the processor instead of the CPU 20a. In this regard, the MPU is an abbreviation of a Micro Processing Unit, the DSP is an abbreviation of a Digital Signal Processor, the ASIC is an abbreviation of an Application Specific Integrated Circuit, and the FPGA is an abbreviation of a Field-Programmable Gate Array.

The memory 20b is an example of hardware which stores information such as various items of data and programs. For example, a non-volatile memory such as a random access memory (RAM) is used as the memory 20b.

The storage 20c is an example of hardware which stores information such as various items of data and programs. Various storage devices such as magnetic disk devices such as HDDs, a semiconductor drive device such as SSDs, and non-volatile memories are used as the storage 20c. The non-volatile memories are, for example, a flash memory, a SCM and a ROM.

For example, the storage 20c may store a program 20h which realizes all or part of various functions of the controller 20. The CPU 20a can realize functions of the communication unit 21, the converter 22, the update unit 23 and the reference unit 24 of the controller 20 illustrated in FIG. 3 by expanding and executing the program 20h stored in the storage 20c to the memory 20b.

In this regard, in an example illustrated in FIG. 3, the controller 20 and the database 10 are separately provided. However, the present invention is not limited to this, and, for example, the memory 20b or the storage 20c of the controller 20 may realize the database 10. In this case, the memory 20b or the storage 20c may store information such as the original table 11, the block map 13, the group map 14, the column store 15, the normal index 17 and the bitmap filter 18 illustrated in FIG. 3. Further, when the controller 20 and the database 10 are separately provided, the memory 20b or the storage 20c may store these pieces of information in a dispersed manner between the memory 20b or the storage 20c and a storage which realizes the database 10.

The IF 20d is an example of a communication interface which controls connection and communication with the network 40 or the database 10. The IF 20d is, for example, optical communication such as a LAN, an infiniband, a fibre channel (FC), or adaptors based on a universal serial bus (USB) or Bluetooth (registered trademark).

In this regard, the program 20h may be downloaded from the network 40 to the controller 20 via the IF 20d.

The I/O unit 20e may include one or both of an input unit such as mouse, a keyboard or an operation button, and an output unit such as a display or a printer.

The reader 20f is an example of a reader which reads information of data and programs recorded in a recording medium 20g. The reader 20f may include a connection terminal or a device which the recording medium 20g can be connected with or inserted in. The reader 20f is, for example, an adaptor based on a USB, a drive device which accesses a recording disk, and a card reader which accesses a flash memory of an SD card. In this regard, the program 20h may be stored in the recording medium 20g.

The recording medium 20g is illustratively a non-transitory recording medium such as magnetic/optical disks or flash memories. The magnetic/optical disks are illustratively flexible disks, compact discs (CD), digital versatile discs (DVD), Blu-ray disks or holographic versatile discs (HVD). The flash memories are illustratively a USB memory or a SD card. In this regard, the CDs are illustratively, a CD-ROM and a CD-RW. Further, the DVDs are illustratively, a DVD-ROM, a DVD-RAM, a DVD-R, a DVD-RW, a DVD+R and a DVD+RW.

The hardware configuration of the controller 20 is an exemplary configuration. Hence, hardware in the controller 20 may be increased or decreased (e.g., arbitrary blocks may be added or removed), divided, arbitrarily combined and integrated, or a bus may be optionally added or removed.

### [2] Others

The technique according to one embodiment can be modified and changed as follows.

For example, each functional block of the controller 20 illustrated in FIG. 3 may be arbitrarily combined and integrated or may be divided.

Further, the function of the controller 20 may be realized by the CPU 20a of a multiprocessor or a multicore. Furthermore, the functions of the controller 20 and the database 10 may be dispersed in a plurality of computers or made redundant and arranged as in cloud environment, for example.

Still further, the controller 20 and the database 10 may be integrated as one computer in the information processing system 1.

The column segment 16 is generated per block group in one embodiment. However, the present invention is not limited to this. For example, the column segment 16 may be generated per DB block 12. In this case, the DB block 12 is an example of a group of a plurality of records, and the block map 13 is an example of group information indicating whether or not the column segment 16 corresponding to each group is valid.

As described above, according to one aspect of one embodiment, it is possible to improve both of database processing performance and use efficiency.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a illustrating of the superiority and inferiority of the invention. Although one or more embodiment(s) of the present invention have been described in detail, it should be understood that the various changes, substitutions, and alterations could be made hereto without departing from the spirit and scope of the invention.

What is claimed is:

1. An information processing system comprising:
a storage device configured to store a row-oriented database and a column-oriented database converted from the row-oriented database; and
a control device configured to control the storage device,
wherein the control device is configured to group a plurality of records included in the row-oriented database into a plurality of groups, and convert each of the groups into a column group conforming to a format of the column-oriented database.

2. The information processing system according to claim 1, wherein the control device is configured to perform the conversion based on group information indicating whether or not the column group corresponding to each of the groups is valid.

3. The information processing system according to claim 2, wherein the control device is configured to, when updating all of a plurality of records in a group of an invalid column group is ensured, convert a group for which the update is ensured into a column group, and set to the group information that the converted column group is valid.

4. The information processing system according to claim 2, wherein the control device is configured to set to the group information that a column group of a group including a record updated by the row-oriented database is invalid.

5. The information processing system according to claim 2, wherein the control device is configured to determine a read target of a record based on the group information from one of the row-oriented database and the column-oriented database, the record being designated by a reference request for the row-oriented database, and read the record designated by the reference request from the determined read target.

6. The information processing system according to claim 5, wherein the control device is configured to
generate relationship information indicating identification information and a relative position, the identification information indicating each record in the converted group, and the relative position being a relative position of data corresponding to the record in a column group generated by the conversion,
specify the record designated by the reference request by using an index set to the row-oriented database, and
specify the relative position of the data in the column group corresponding to the record specified by using the index based on the relationship information when the read target is the column-oriented database.

7. The information processing system according to claim 6, wherein the control device is configured to set the record to a bitmap, the record being specified by using the index and the bitmap being arranged in order of identification information of records, and determine whether or not the record set to the bitmap is the read target in order of the identification information of the records.

8. The information processing system according to claim 5, wherein the control device is configured to select the row-oriented database when a column group of a group including the record designated by the reference request is invalid, and select the column-oriented database when the column group of the group including the record designated by the reference request is valid.

9. The information processing system according to claim 1, wherein the control device is configured to generate information for each data in the column group generated by the conversion, the information indicating a relationship with identification information of a corresponding record in the converted group.

10. A control device comprising:
a memory; and
a processor coupled to the memory,
wherein the processor is configured to group a plurality of records included in a row-oriented database into a plurality of groups, and convert each of the groups into a column group conforming to a format of a column-oriented database.

11. The control device according to claim 10, wherein the processor is configured to perform the conversion based on group information indicating whether or not the column group corresponding to each of the groups is valid.

12. The control device according to claim 11, wherein the processor is configured to, when updating all of a plurality of records in a group of an invalid column group is ensured, convert a group for which the update is ensured into a column group, and set to the group information that the converted column group is valid.

13. The control device according to claim 11, wherein the processor is configured to set to the group information that a column group of a group including a record updated by the row-oriented database is invalid.

14. The control device according to claim 11, wherein the processor is configured to determine a read target of a record based on the group information from one of the row-oriented database and the column-oriented database, the record being designated by a reference request for the row-oriented database, and read the record designated by the reference request from the determined read target.

15. A non-transitory computer-readable recording medium having stored therein a processing program for causing a computer to execute a process comprising grouping a plurality of records included in a row-oriented database into a plurality of groups, and converting each of the groups into a column group conforming to a format of a column-oriented database.

16. The non-transitory computer-readable recording medium having stored therein the processing program according to claim 15, wherein the process further comprises performing the conversion based on group information indicating whether or not the column group corresponding to each of the groups is valid.

17. The non-transitory computer-readable recording medium having stored therein the processing program according to claim 16, wherein the process further comprises converting a group for which the update is ensured into a column group, and setting to the group information that the converted column group is valid when updating all of a plurality of records in a group of an invalid column group is ensured.
